(19) United States
(12) Patent Application Publication
(10) Pub. No.: US 2026/0277532 A1
(43) Pub. Date: Sep. 17, 2026

(54) AUDIO PROCESSING METHOD AND APPARATUS, ELECTRONIC DEVICE AND COMPUTER-READABLE STORAGE MEDIUM

(71) Applicant: SHENZHEN TCL NEW TECHNOLOGY CO., LTD., Shenzhen, Guangdong (CN)

(72) Inventors: Feng ZHU, Shenzhen, Guangdong (CN); Junying LI, Shenzhen, Guangdong (CN)

(73) Assignee: SHENZHEN TCL NEW TECHNOLOGY CO., LTD., Shenzhen, Guangdong (CN)

(21) Appl. No.: 19/166,869

(22) PCT Filed: Mar. 20, 2024
(86) PCT No.: PCT/CN2024/082818

§ 371 Date: Sep. 18, 2025

(30) Foreign Application Priority Data
Mar. 24, 2023 (CN) 202310336546.3

(51) Int. Cl. G06F 3/16; H04L 67/568; H04W 76/10

(52) U.S. Cl. CPC G06F 3/162; H04L 67/568; H04W 76/10

(57) ABSTRACT

Embodiments of the present application disclose an audio processing method and apparatus, an electronic device, and a computer-readable storage medium. In the present method, an audio reading cycle is determined by means of a transmission performance level of an audio transmission link, and an audio reading frequency is adjusted according to the transmission performance, ensuring that reading and transmission of audio are able to fully utilize the transmission performance of the audio transmission link to improve the audio transmission quality while meeting transmission performance requirements.

The present application claims priority to Chinese Patent Application No. 202310336546.3, entitled “AUDIO PROCESSING METHOD AND APPARATUS, ELECTRONIC DEVICE AND COMPUTER-READABLE STORAGE MEDIUM” and filed on Mar. 24, 2023, the entire contents of which are incorporated herein by reference.

### TECHNICAL FIELD

Embodiments of the present application relate to the field of computer technology, specifically to an audio processing method, apparatus, electronic device, and computer-readable storage medium.

### BACKGROUND

After recording or generating audio, an audio transmitting device writes corresponding audio data into a buffer, then reads the audio data from the buffer and transmits it to an audio playback device for audio rendering.

### TECHNICAL PROBLEM

The buffer during audio transmission is a critical factor affecting the audio transmission quality. How to adjust the frequency or cycle of reading audio from the buffer holds significant importance for audio transmission.

### SUMMARY

Embodiments of the present application provide an audio processing method, apparatus, electronic device, and computer-readable storage medium, which is able to adjust audio reading cycles to improve the audio transmission quality.

The embodiments of the application provide an audio processing method, including: if an audio transmission link is established with a peer device, determining an audio reading cycle based on a transmission performance level of the audio transmission link; reading target audio data from an audio buffer of the current device according to the audio reading cycle; and transmitting the target audio data to the peer device via the audio transmission link.

Correspondingly, embodiments of the present application further provide an audio processing apparatus, comprising: a determination module configured to determine an audio reading cycle based on a transmission performance level of the audio transmission link if an audio transmission link is established with a peer device, ; a reading module configured to read target audio data from an audio buffer of a current device according to the audio reading cycle; and a transmission module configured to transmit the target audio data to the peer device via the audio transmission link.

Optionally, in some embodiments of the present application, the apparatus further includes a capacity adjustment module, and the capacity adjustment module comprises:
a scenario determination unit configured to determine a current usage scenario of the audio transmission link based on time information of currently started threads; and
a capacity adjustment unit configured to adjust a storage capacity of the audio buffer according to the current usage scenario.

In some embodiments of the present application, the scenario determination unit includes:
a first determination subunit configured to determine a currently running application based on the time information of the currently started threads; and
a second determination subunit configured to determine the current usage scenario of the audio transmission link based on an application type of the currently running application.

In some embodiments of the present application, the transmission module includes:
a storage unit configured to store the target audio data in an audio queue to be transmitted of the current device; and
a transmission unit configured to transmit the target audio data in the audio queue to be transmitted to the peer device via the audio transmission link;
wherein the capacity adjustment unit comprises:
an adjustment subunit configured to adjust a storage capacity of the audio buffer and a storage capacity of the audio queue to be transmitted based on a preset capacity adjustment threshold and the current usage scenario.

In some embodiments of the present application, the apparatus further includes a performance determination module comprising:
a parameter acquisition unit configured to acquire transmission performance parameters of the audio transmission link according to a preset frequency period;
a score determination unit configured to determine a transmission performance score based on reference weights corresponding to each transmission performance parameter; and
a level determination unit configured to determine the transmission performance level of the audio transmission link based on the transmission performance score;
wherein the transmission performance parameters comprise at least one of signal transmission power, signal reception strength, and packet loss rate.

In some embodiments of the present application, the level determination unit includes:
an acquisition subunit configured to acquire a mapping relationship set, wherein the mapping relationship set comprises a mapping relationship between preset transmission performance scores and preset transmission performance levels; and
a third determination subunit configured to determine the transmission performance level corresponding to the transmission performance score according to the mapping relationship.

In some embodiments of the present application, the transmission performance level is a current transmission performance level acquired in a current frequency period, and the determination module comprises:
a cycle acquisition unit configured to acquire a historical transmission performance level of the audio transmission link and a historical audio reading cycle corresponding to the historical transmission performance level, wherein the historical transmission performance level is acquired in a previous frequency period of the current frequency period;
a first cycle determination unit configured to, if the current transmission performance level is higher than the historical transmission performance level, decrease the historical audio reading cycle according to a preset cycle adjustment threshold to obtain the audio reading cycle corresponding to the current transmission performance level;
a second cycle determination unit configured to, if the current transmission performance level is lower than the historical transmission performance level, increase the historical audio reading cycle according to the preset cycle adjustment threshold to obtain the audio reading cycle corresponding to the current transmission performance level; and
a third cycle determination unit configured to, if the current transmission performance level is equal to the historical transmission performance level, use the historical audio reading cycle as the audio reading cycle corresponding to the current transmission performance level.

In a third aspect, embodiments of the present application provide an electronic device including a memory, a processor, and a computer program stored in the memory and executable on the processor, wherein the computer program implements the steps of the aforementioned audio processing method when executed by the processor.

In a fourth aspect, embodiments of the present application provide a computer-readable storage medium storing a computer program that, when executed by a processor, implements the steps of the aforementioned audio processing method.

In a fifth aspect, embodiments of the present application provide a computer program product or computer program comprising computer instructions stored on a computer-readable storage medium. A processor of a computing device reads the computer instructions from the medium and executes them, causing the device to perform the method described in various implementations of the present application.

### BENEFICIAL EFFECTS

In the embodiments of the present application, when an audio transmission link is established between the current device and a peer device, an audio reading cycle is determined based on the transmission performance level of the audio transmission link, and target audio data is read from the audio buffer of the current device according to the audio reading cycle and transmitted to the peer device via the audio transmission link. The audio reading cycle is determined based on the transmission performance level of the audio transmission link, the target audio data is read according to the audio reading cycle and transmitted, and the audio reading frequency is adjusted according to the transmission performance. This solution ensures that reading and transmission of audio are able to fully utilize the transmission performance of the audio transmission link to improve the audio transmission quality while meeting transmission performance requirements.

### BRIEF DESCRIPTION OF THE DRAWINGS

To illustrate the technical solutions in the embodiments of the present application more clearly, the following briefly introduces the accompanying drawings of the embodiments. Obviously, the drawings presented below are only some embodiments of the present invention. Those skilled in the art may obtain additional drawings based on these drawings without creative effort.

FIG. 1 is a schematic diagram of a scenario of an audio processing method according to some embodiments of the present application;

FIG. 2 is a flowchart of an audio processing method according to some embodiments of the present application;

FIG. 3 is another flowchart of an audio processing method according to some embodiments of the present application;

FIG. 4 is an illustrative diagram of a mapping relationship between transmission performance scores of an audio transmission link and audio reading cycles according to some embodiments of the present application;

FIG. 5 is a schematic diagram of audio data flow direction according to some embodiments of the present application;

FIG. 6 is a flowchart of audio transmission according to some embodiments of the present application;

FIG. 7 is a structural schematic diagram of an audio processing apparatus according to some embodiments of the present application; and

FIG. 8 is a structural schematic diagram of an electronic device according to some embodiments of the present application.

### DETAILED DESCRIPTION OF THE EMBODIMENTS

The technical solutions in the present application will be clearly and completely described below with reference to the accompanying drawings. Obviously, the described embodiments are only a part of the embodiments of the present invention rather than all of them. All other embodiments obtained by those skilled in the art based on the embodiments of the present application without creative efforts shall fall within the protection scope of the present application.

The present application provides an audio processing method, apparatus, electronic device, and computer-readable storage medium. Specifically, the embodiments of the present application provide an audio processing apparatus applicable to electronic devices, where the electronic devices include terminals, and the terminals include but not limited to computers, televisions, tablets, Bluetooth speakers, or mobile phones, etc.

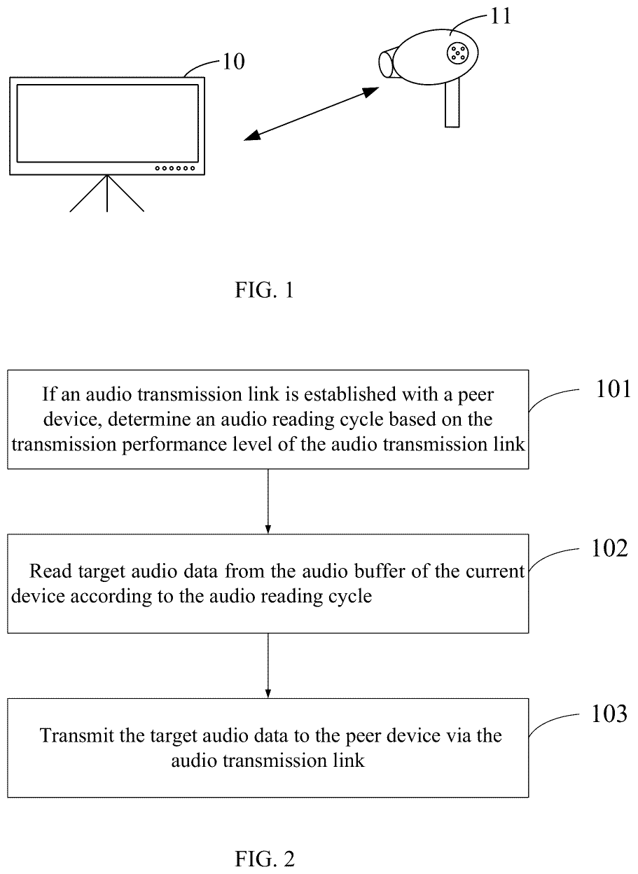

Referring to FIG. 1, taking a television executing the audio processing method as an example, the specific implementation process is as follows:
After an application installed on television 10 responds to operations and generates audio, it writes the audio into an audio buffer. If an audio transmission link is established between television 10 and peer device 11, an audio reading cycle is determined based on the transmission performance level of the audio transmission link. Subsequently, corresponding audio data is read from the audio buffer according to the audio reading cycle and the audio data is transmitted to peer device 11 via the audio transmission link. Peer device 11 then plays the audio corresponding to the audio data.

It should be noted that the peer device is an audio playback-capable device, such as a headset, a Bluetooth headset, or a speaker.

Correspondingly, the audio transmission link may be a Bluetooth link established using Bluetooth technology.

In the embodiments of the present application, when an audio transmission link is established between the current device and a peer device, an audio reading cycle is determined based on the transmission performance level of the audio transmission link, and target audio data is read from the audio buffer of the current device according to the audio reading cycle and transmitted to the peer device via the audio transmission link. The audio reading cycle is determined based on the transmission performance level of the audio transmission link, the target audio data is read according to the audio reading cycle and transmitted, and the audio reading frequency is adjusted according to the transmission performance, ensuring that reading and transmission of audio are able to fully utilize the transmission performance of the audio transmission link to improve the audio transmission quality while meeting transmission performance requirements.

The following provides detailed descriptions. It is noted that the description order of the embodiments s does not limit the preference of the embodiments.

Referring to FIG. 2, a flowchart of the audio processing method according to some embodiments is illustrated. The steps of the audio processing method are as follows:
101. If an audio transmission link is established with a peer device, determine an audio reading cycle based on the transmission performance level of the audio transmission link.

It is noted that the peer device in embodiments refers to an audio playback-capable device, such as a Bluetooth headset or speakers.

Correspondingly, the audio transmission link is a link established based on audio transmission technology, which may be a Bluetooth transmission link established based on Bluetooth technology.

It is noted that the transmission performance level describes the performance of the audio transmission link in transmitting data. A higher level indicates more abundant link resources and better audio transmission performance.

It is noted that the audio reading cycle is the cycle for reading audio, which can also be understood as the frequency of reading audio. For example, a fixed timer is set to read audio data every 20 ms, or to read audio data at an interval of 20 ms.

It can be understood that determining the audio reading cycle based on the transmission performance level of the audio transmission link ensures that the audio reading cycle can meet or conform to the requirements of the transmission performance level. For example, when the transmission performance level is high, the audio reading cycle may be appropriately reduced; when the transmission performance level is low, the audio reading cycle may be appropriately increased.

102. Read target audio data from the audio buffer of the current device according to the audio reading cycle.

It should be noted that the current device is the device that generates the audio data or transmits the audio data. For example, the current device generates audio data for transmission after recording, or after a user operates the current device, a corresponding application within the current device generates corresponding audio data.

Correspondingly, after generating the corresponding audio data, the current device stores this audio data in the audio buffer, and a corresponding thread executes to read data from this audio buffer. In embodiments of the present application, data is read from the audio buffer based on the audio reading cycle, ensuring that the reading of audio data can meet the transmission performance requirements of the audio transmission link. For example, when the audio reading cycle decreases according to the transmission performance level, the frequency of reading audio data from the audio buffer can be increased, enabling rapid reading of audio data and reducing the end-to-end delay; when the audio reading cycle increases according to the transmission performance level, it indicates insufficient link bandwidth resources, and the frequency of reading audio data from the audio buffer can be reduced to decrease audio data loss.

It can be understood that determining the audio reading cycle according to the transmission performance level of the audio transmission link and reading the target audio data from the audio buffer according to this audio reading cycle ensures that the reading of the target audio data meets the performance resource conditions of the audio transmission link, guaranteeing the effectiveness, stability, and security of audio data transmission.

103. Transmit the target audio data to the peer device via the audio transmission link.

Herein, by transmitting the read target audio data to the peer device via the audio transmission link, it facilitates the peer device to read and play this target audio data. For example, when a user controls a game on a television, the audio data generated by controlling the game can be transmitted to a Bluetooth headset via a Bluetooth transmission link and played by the Bluetooth headset for the user wearing them.

In the embodiments of the present application, when the audio transmission link is established between the current device and a peer device, the audio reading cycle is determined according to the transmission performance level of the audio transmission link, target audio data is read from the audio buffer of the current device according to the audio reading cycle, and the target audio data is transmitted to the peer device via the audio transmission link. Herein, the audio reading cycle is determined based on the transmission performance level of the audio transmission link, the target audio data is read according to the audio reading cycle and transmitted, and the audio reading frequency is adjusted according to the transmission performance, ensuring that reading and transmission of audio are able to fully utilize the transmission performance of the audio transmission link to improve the audio transmission quality while meeting transmission performance requirements.

Optionally, since preventing audio loss is also a manifestation of transmission performance, and the buffer size has an impact on preventing audio loss, in embodiments of the present application, the size of the buffer can also be adjusted to prevent audio loss and ensure sound quality. That is, optionally, in some embodiments of the present application, after the step “if an audio transmission link is established with a peer device”, the method further includes:
determining a current usage scenario of the audio transmission link according to time information of currently started threads; and
adjusting a storage capacity of the audio buffer according to the current usage scenario.

It should be noted that the time information of a thread is the time information when the thread is started or executed. This time information reflects the execution status of threads that are currently running or have just finished running at the current stage. According to this thread execution status, the device's current usage scenario can be analyzed.

It can be understood that different usage scenarios have different requirements for sound quality. For example, in a music listening scenario, the requirement for sound quality is higher; in a game operation scenario, the requirement for link latency is higher. Therefore, the buffer size can be adjusted according to different scenarios.

Correspondingly, when the buffer is small, data in the buffer is likely to be overwritten and lost, leading to poor sound quality. Therefore, for scenarios requiring high sound quality, the buffer capacity can be expanded to avoid audio data loss. When the buffer is large, data in the buffer is not likely to be overwritten and lost, which can guarantee audio quality and sound fidelity. However, an excessively large buffer may cause link latency issues. Therefore, in embodiments of the present application, for scenarios with lower latency requirements, the buffer size can be appropriately reduced to reduce the link latency.

Optionally, in embodiments of the present application, when determining the usage scenario based on threads, the current usage scenario can be determined according to the application type to which the threads belong. That is, optionally, in some embodiments of the present application, the step “determining the current usage scenario of the audio transmission link according to time information of currently started threads” includes:

determining a currently running application according to time information of currently started threads; and determining a current usage scenario of the audio transmission link according to an application type of the currently running application.

It can be understood that based on the time information, several threads close to the current time can be filtered out, and each thread corresponds to an application. Therefore, the currently used or running application can be determined based on these several threads, and the current usage scenario can be determined according to the application type of this application. For example, if analysis based on threads indicates that the currently running application is a shooting game application, then the current usage scenario can be determined as a low-latency scenario; if analysis based on threads indicates that the currently running application is a music player, then the current usage scenario can be determined as a high-sound-quality scenario.

Correspondingly, in embodiments of the present application, the current usage scenarios include but are not limited to a low-latency scenario and a high-sound-quality scenario. Correspondingly, these scenarios can be designed based on the distinction in buffer size according to user requirements.

Audio data needs to be transmitted via a queue when transmitted via the audio transmission link, therefore, when transmitting audio via the audio transmission link, the audio data is first read from the audio buffer into a queue, and then the audio data in the queue is transmitted to the peer device via the transmission link. That is, optionally, in some embodiments of the present application, the step “transmitting the target audio data to the peer device via the audio transmission link” includes:
storing the target audio data in an audio queue to be transmitted of the current device; and
transmitting the target audio data in the audio queue to be transmitted to the peer device via the audio transmission link.

It can be understood that by writing the audio data into a corresponding queue, this queue can be used to transmit the audio data to the peer device via the audio transmission link. For example, after a player/game application runs and generates audio, it creates an AudioTrack and calls the write function to write the sound audio data into AudioFlinger. AudioFlinger will write the sound audio data into the Bluetooth HAL (Hardware Abstraction Layer), and then call Out WritePcmData to write the data into the audio buffer (FMQ, Fast Message Queue). The Bluetooth protocol stack starts a thread that uses a fixed timer of 20 ms to read the sound audio data from the audio buffer FMQ, stores it in the audio queue to be transmitted (tx_audio_queue), then encodes the read PCM data. The encoded data is transmitted to the peer Bluetooth headset via the Bluetooth module (audio transmission link). The Bluetooth headset decode the received data and play it.

Correspondingly, when transmitting the audio data via the queue, the capacity of this queue can also be adjusted according to the current usage scenario to achieve a balance between audio quality and low latency. That is, optionally, in some embodiments of the present application, the step “adjusting the storage capacity of the audio buffer according to the current usage scenario” includes:
adjusting the storage capacity of the audio buffer and the storage capacity of the audio queue to be transmitted according to the current usage scenario and a preset capacity adjustment threshold.

It can be understood that the preset capacity adjustment threshold is a predetermined threshold. This threshold can be defined based on actual needs or empirical parameters, or it can change dynamically according to changes in memory. For example, if the current storage capacity is large, the preset capacity adjustment threshold can be set relatively small; otherwise, the preset capacity adjustment threshold can be set relatively large.

Correspondingly, when audio data overflows and is lost due to the small capacity of the audio buffer, the audio data in the audio queue to be transmitted will also be cleared, leading to loss of audio data that is to be transmitted to the peer device and resulting in poor sound quality. Therefore, when dynamically adjusting the size of the audio buffer based on the usage scenario of the current device, the capacity of the audio queue to be transmitted can also be dynamically adjusted simultaneously to achieve a balance between sound quality and latency during audio transmission. For example, if the user is playing a game, the space size of both the audio buffer and the audio queue to be transmitted is reduced to reduce the overall link latency. If the user is listening to music, the space size of both the audio buffer and the audio queue to be transmitted is increased to ensure audio quality.

Optionally, in embodiments of the present application, transmission performance parameters of the audio transmission link can be collected, and the transmission performance level of the audio transmission link can be analyzed based on the transmission performance parameters. That is, optionally, in some embodiments of the present application, before the step “determining an audio reading cycle according to the transmission performance level of the audio transmission link”, the method further includes:
acquiring transmission performance parameters of the audio transmission link according to a preset frequency period;
determining a transmission performance score according to reference weights corresponding to each of the transmission performance parameters; and
determining the transmission performance level of the audio transmission link according to the transmission performance score;
wherein the transmission performance parameters include at least one of signal transmission power, signal reception strength, and packet loss rate.

Herein, by collecting transmission performance parameters of the audio transmission link during audio transmission, the transmission performance score of this audio transmission link can be obtained based on these transmission performance parameters. Then, based on the correspondence between this transmission performance score and transmission performance levels, the corresponding transmission performance level can be obtained.

It should be noted that in embodiments of the present application, the transmission performance score of the audio transmission link is calculated based on the weights corresponding to each transmission performance parameter. For example, the transmission performance score is calculated with a weight distribution of 20% for signal transmission power (TX Power), 20% for signal reception strength (RSSI), and 60% for packet error rate (PER).

It can be understood that in embodiments of the present application, the transmission performance level corresponding to the currently calculated transmission performance score can be determined based on the mapping relationship between transmission performance scores and transmission performance levels. That is, optionally, in some embodiments of the present application, the step “determining the transmission performance level of the audio transmission link according to the transmission performance score” comprises:
acquiring a mapping relationship set, the mapping relationship set including a mapping relationship between preset transmission performance scores and preset transmission performance levels; and
determining the transmission performance level corresponding to the transmission performance score according to the mapping relationship.

This mapping relationship can be predefined according to actual needs or configured based on experimental results.

Correspondingly, in embodiments of the present application, after acquiring the transmission performance level of the audio transmission link, the audio reading cycle corresponding to the current transmission performance level can also be obtained based on the mapping relationship between the transmission performance level and the audio reading cycle, and different levels have corresponding audio reading cycles.

Optionally, in embodiments of the present application, the audio reading cycle currently required can also be determined by comparing the current transmission performance level with the transmission performance level from a historical period. That is, optionally, in some embodiments of the present application, the transmission performance level is a current transmission performance level acquired in the current frequency period, the step “determining an audio reading cycle according to the transmission performance level of the audio transmission link” includes:
acquiring a historical transmission performance level of the audio transmission link and a historical audio reading cycle corresponding to the historical transmission performance level, where the historical transmission performance level is a transmission performance level acquired in a previous frequency period of the current frequency period;
if the current transmission performance level is higher than the historical transmission performance level, decreasing the historical audio reading cycle according to a preset cycle adjustment threshold to obtain the audio reading cycle corresponding to the current transmission performance level;
if the current transmission performance level is lower than the historical transmission performance level, increasing the historical audio reading cycle according to a preset cycle adjustment threshold to obtain the audio reading cycle corresponding to the current transmission performance level;
if the current transmission performance level is equal to the historical transmission performance level, using the historical audio reading cycle as the audio reading cycle corresponding to the current transmission performance level.

It should be noted that the transmission performance parameters of the audio transmission link are acquired at a certain frequency. Correspondingly, a corresponding transmission performance level is also generated with each acquisition frequency scoring. In embodiments of the present application, the historical transmission performance level is the previous scoring result of the current transmission performance level.

It can be understood that if the current transmission performance level is higher than the historical transmission performance level, it indicates that the current audio transmission link resources are better than those in the previous time. Based on this, the audio reading cycle can be appropriately reduced to increase the frequency of reading audio data and reduce link latency. Conversely, if the current transmission performance level is lower than the historical transmission performance level, it indicates that the current audio transmission link resources are worse than those in the previous time. Based on this, the audio reading cycle can be appropriately increased to reduce the frequency of reading audio data and decrease audio data loss.

It can be understood that the preset cycle adjustment threshold is a predetermined adjustment threshold, which corresponds to an adjustment amplitude, such as 5 ms. This threshold can be dynamically adjusted according to actual needs or predefined based on empirical parameters.

In embodiments of the present application, by analyzing the usage scenario of the audio transmission link and adjusting the capacity of the audio buffer and the audio queue based on the scenario, the audio transmission process can achieve a corresponding balance between link latency and sound quality, i.e., the capacity is dynamically adjusted according to the requirements of different scenarios.

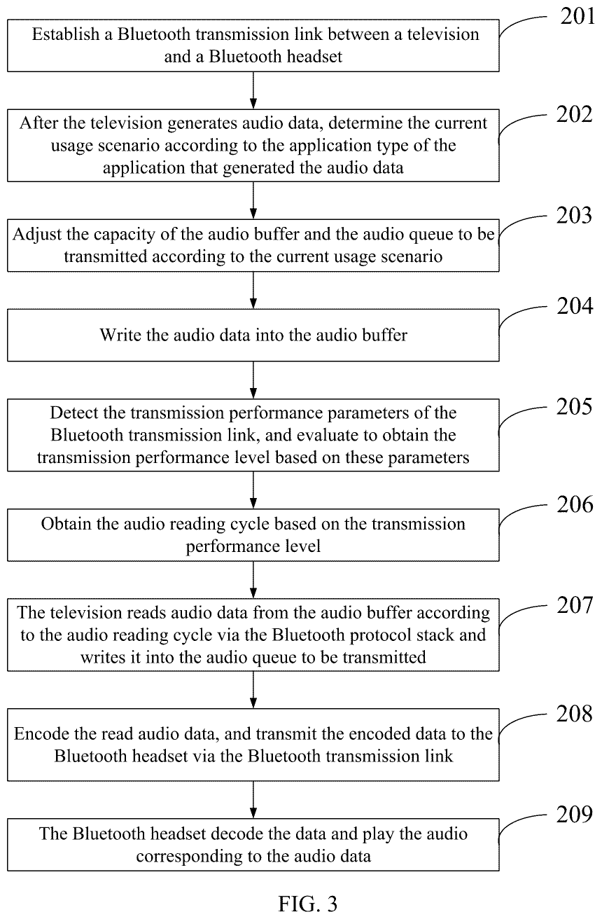

Please refer to FIG. 3, which is another schematic flowchart of an audio processing method according to embodiments of the present application. The steps of this audio processing method include:
201. Establish a Bluetooth transmission link between a television and a Bluetooth headset;
202. After the television generates audio data, determine the current usage scenario according to the application type of the application that generated the audio data;

The television system starts a scenario detection service to learn the current user usage scenario in real time.

It should be noted that in embodiments of the present application, the current usage scenarios include a low-latency scenario and a high-sound-quality scenario. It can be understood that different applications correspond to different usage scenarios. For example, game applications correspond to low-latency scenarios, and music applications correspond to high-sound-quality scenarios.

203. Adjust the capacity of the audio buffer and the audio queue to be transmitted according to the current usage scenario;

Based on the specific scenario, the system dynamically adjusts the space size of the FMQ and tx_audio_queue. For example, if the user is currently playing a game, the buffer space size is gradually reduced to lower the overall Bluetooth audio latency. When the user is currently listening to music, the buffer space size is gradually increased to ensure Bluetooth audio quality. When gradually and dynamically adjusting the buffer space, the most suitable value between audio stuttering and audio latency is found.

It can be understood that by adjusting the capacity of the audio buffer and the audio queue to be transmitted based on the current usage scenario, the transmission link can achieve a balance between low latency and high sound quality. For example, the transmission conditions can be adjusted accordingly based on different requirements.

204. Write the audio data into the audio buffer;

Herein, after the audio data is generated, an Audio Track is created, and the write function is called to write the sound audio data into AudioFlinger. AudioFlinger will write the sound audio data into the Bluetooth HAL (Hardware Abstraction Layer), and then call OutWritePcmData to write the data into the audio buffer (FMQ, Fast Message Queue).

205. Detect the transmission performance parameters of the Bluetooth transmission link, and evaluate to obtain the transmission performance level based on these parameters;

It should be noted that the transmission performance parameters include but are not limited to signal transmission power (TX Power), signal reception strength (RSSI), and packet error rate (PER). The transmission performance score can be obtained based on the weights of each transmission performance parameter, and then the current transmission performance level of the audio transmission link can be obtained based on the mapping relationship between the transmission performance score and the transmission performance level.

The television system starts a Bluetooth performance detection service to obtain the current Bluetooth performance and Bluetooth link bandwidth usage in real time. The Bluetooth performance detection is initiated every 1 second cycle. The transmission performance level is divided into five levels, each level has a corresponding timer period. If the performance is good, the timer period is reduced; if the performance is poor, the timer period is increased.

206. Obtain the audio reading cycle based on the transmission performance level;

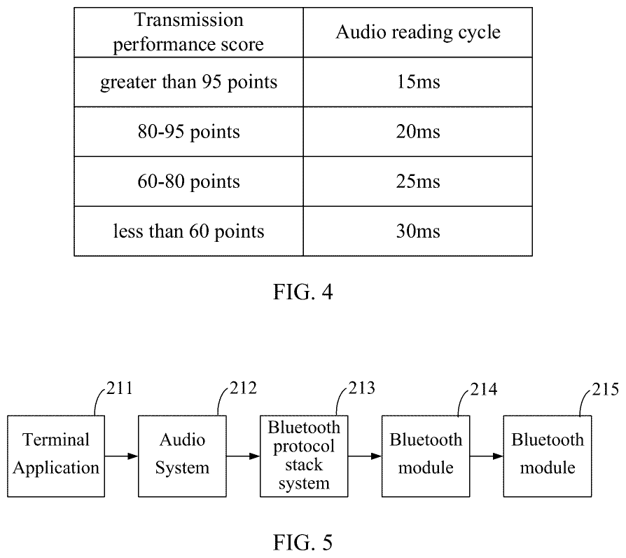

Please refer to FIG. 4. FIG. 4 is a mapping relationship diagram between the transmission performance score of the audio transmission link and the audio reading cycle according to embodiments of the present application. Different transmission performance scores correspond to different transmission performance levels. In embodiments of the present application, each transmission performance level corresponds to an interval of transmission performance scores.

The Bluetooth performance situation is divided into levels, and the timer period for reading FMQ audio data is dynamically adjusted. If the current Bluetooth performance is high, the timer period is gradually reduced; if the current Bluetooth performance is low, the timer period is gradually increased.

It can be understood that different transmission performance levels correspond to different link resources. Therefore, to fully utilize link resources, different transmission performance levels correspond to different audio reading cycles to achieve full utilization of link resources.

207. The television reads audio data from the audio buffer according to the audio reading cycle via the Bluetooth protocol stack and writes it into the audio queue to be transmitted;

208. Encode the read audio data, and transmit the encoded data to the Bluetooth headset via the Bluetooth transmission link;

209. The Bluetooth headset decodes the data and plays the audio corresponding to the audio data.

It can be understood that by adjusting the storage capacity based on the usage scenario of the audio transmission link, a balance between low latency and high sound quality is achieved. For different usage scenarios, the storage capacity can be adjusted accordingly to meet the corresponding link transmission requirements. For example, based on the user's actual specific usage scenario, the space size of the audio buffer (FMQ) and the audio queue to be transmitted (tx_audio_queue) are dynamically adjusted. If the user is currently playing a game, the buffer space size is reduced to lower the overall link latency; if the user is currently listening to music, the buffer space size is increased to ensure audio quality.

Secondly, by adjusting the audio reading cycle based on the link transmission performance, full utilization of link resources can be achieved. For example, when the Bluetooth performance is good, or the Bluetooth link bandwidth resources are sufficient, the timer period is gradually reduced, speeding up the reading of FMQ audio data. This can improve the end-to-end latency without affecting audio quality. When the Bluetooth performance is poor, or the overall Bluetooth link bandwidth resources are insufficient, the timer period is gradually increased to reduce audio data loss.

Please refer to FIG. 5. FIG. 5 is a schematic diagram of the direction of audio data flow according to embodiments of the present application. The direction of audio data flow includes:
Terminal Application 211: used to generate corresponding audio data in response to user operations. For example, the user operates a game application in the terminal, and corresponding game audio is generated.

Audio System 212: used to write the audio data generated by the terminal application 211 into the audio buffer. For example, after the audio data is generated, an AudioTrack is created, and the write function is called to write the sound audio data into AudioFlinger. AudioFlinger processes the audio data (e.g., resampling) and then writes the PCM (Pulse-Code Modulation) format audio data into the current device node Bluetooth HAL. Then, Out WritePcmData is called to write the data into the audio buffer (FMO, Fast Message Queue).

Bluetooth protocol stack system 213: used to read audio data from the audio buffer according to the audio reading cycle and write it into the to-be-transmitted audio queue.

Bluetooth module 214: used to transmit the audio data in the to-be-transmitted audio queue to the peer device (e.g., a Bluetooth headset) based on the Bluetooth transmission link.

The peer device 215, including a Bluetooth headset, plays the received audio data.

The capacity of the audio buffer and the audio queue to be transmitted of the audio system is adjusted based on the usage scenario of the Bluetooth module, achieving capacity adjustment according to application requirements to meet corresponding needs.

The audio reading cycle is adjusted based on the transmission performance of the transmission link of the Bluetooth module, adjusting the frequency of reading audio data from the audio buffer, achieving full utilization of link resources while meeting audio transmission performance requirements.

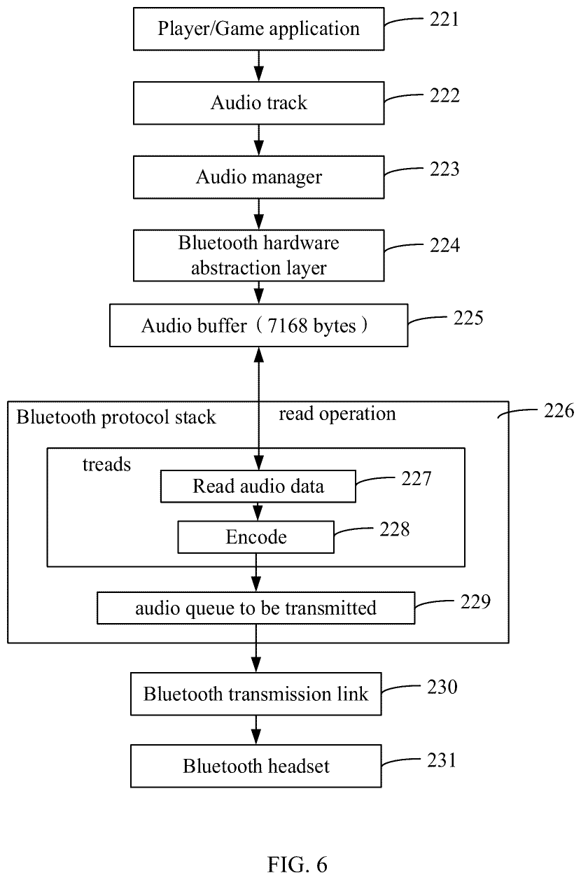

Please refer to FIG. 6. FIG. 6 is a schematic flowchart of audio transmission according to embodiments of the present application. The flowchart of audio transmission in the related art includes:
After a player or game application 221 generates audio data, an audio track 222 is created, and the audio data is written into the audio track 222. The write function is called to write the audio data in the audio track 222 into the audio manager 223. The audio data in the audio manager 223 is written into the Bluetooth hardware abstraction layer 224. An output write function (OutWritePcmData) is called to write the data from the Bluetooth hardware abstraction layer 224 into the audio buffer (FMO, Fast Message Queue) 225. By default, the capacity of the audio buffer 225 is 7168 bytes.

Subsequently, the Bluetooth protocol stack 226 starts a thread and executes the following steps:
Read audio data 227: Specifically, read audio data 227 from the audio buffer 225 according to a fixed timer (e.g., 20 ms), such as a 2dp_source_audio_handle_timer (20 ms);
Encode 228: Encode the read audio data (SBC Encoder) to obtain encoded result data;
The encoded result data is written into the audio queue to be transmitted 229. By default, the capacity of the audio queue to be transmitted 229 is 28 bytes. Subsequently, the encoded result data in the audio queue to be transmitted 229 is transmitted to the Bluetooth headset 231 via the Bluetooth transmission link 230.

In the related art, reading audio data from the audio buffer 225 with a fixed 20 ms timer cannot fully utilize link resources. Furthermore, storing audio data with a fixed capacity buffer cannot achieve a balance between low link latency and high sound quality.

Based on this, in embodiments of the present application, the audio transmission process of the related art is optimized, including adjustments related to reading audio data 227, the audio buffer 225, and the audio queue to be transmitted 229. Specifically:
In the step of reading audio data 227, the specific period of 20 ms in the relevant command (a2dp_source_audio_handle_timer(20 ms)) for reading audio data with a fixed timer is adjusted from 20 ms to Xms, e.g., a2dp_source_audio_handle_timer(Xms), where X represents a dynamically variable audio reading cycle.

The capacity of audio buffer 225 is adjusted from FMQ (7168 bytes) to FMQ (Y bytes), where Y represents the dynamically variable capacity value. The capacity (tx-audio-queue (28)) of the audio queue to be transmitted 229 is adjusted to tx-audio-queue (Z), where Z represents the dynamically variable capacity value.

By adjusting the frequency or cycle at which audio data is read from the audio buffer 225, the link resources can be fully utilized while meeting the link performance requirements. By adjusting the capacities of the audio buffer 225 and the audio queue to be transmitted 229, a balance between low latency and high audio quality can be achieved on the link.

To facilitate implementing audio processing method according to embodiments of the present application, an audio processing device based on the aforementioned audio processing method is provided. The meanings of the nouns are the same as those in the aforementioned audio processing method, and the details of the embodiments can be referred to in the description of the method embodiments.

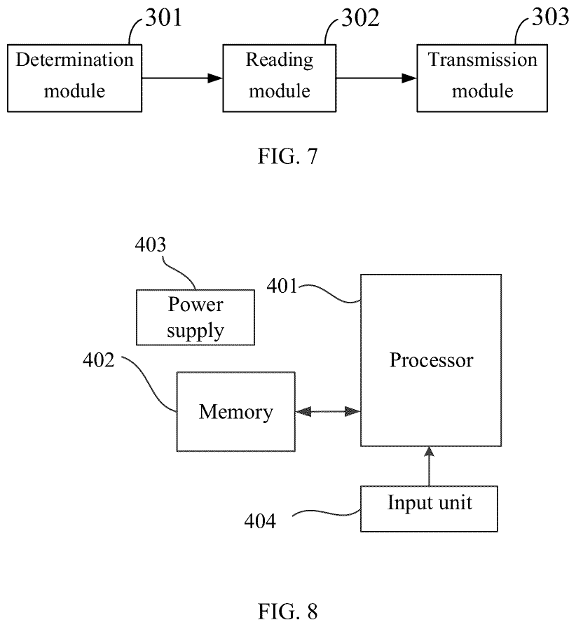

Please refer to FIG. 7. FIG. 7 is a structural schematic diagram of the audio processing device according to embodiments of the present application. The audio processing may include:
Determination module 301, which used to determine the audio reading cycle according to transmission performance level of the audio transmission link if an audio transmission link is established with the peer device ;.

Reading module 302, configured to read the target audio data from the audio buffer of the current device according to the audio reading cycle; and
Transmission module 303, configured to transmit the target audio data to the peer device via the audio transmission link.

Optionally, in some embodiments of the present application, the device further includes a capacity adjustment module, and the capacity adjustment module includes:
Scene determination unit, configured to determine the current usage scenario of the audio transmission link based on the time information of the currently started thread; and
Capacity adjustment unit, configured to adjust the storage capacity of the audio buffer according to the current usage scenario.

In some embodiments of the present application, the scene determination unit includes:
A first determination subunit, configured to determine the currently running application based on the time information of the currently started thread;
A second determination subunit, configured to determine the current usage scenario of the audio transmission link based on the application type of the currently running application.

In some embodiments of the present application, the transmission module 303 includes:
A storage unit, configured to store the target audio data into the audio queue to be transmitted of the current device; and
A transmission unit, configured to transmit the target audio data in the audio queue to be transmitted via the audio transmission link to the peer device.

The capacity adjustment unit includes:
An adjustment subunit, configured to adjust the storage capacity of the audio buffer and the storage capacity of the audio queue to be transmitted according to the current usage scenario and the preset capacity adjustment threshold.

In some embodiments of the present application, the device further includes a performance determination module, and the performance determination module includes:
A parameter acquisition unit, configured to acquire the transmission performance parameters of the audio transmission link according to the preset frequency period;
A score determination unit, configured to determine the transmission performance score based on the reference weights corresponding to each transmission performance parameter;
A level determination unit, configured to determine the transmission performance level of the audio transmission link based on the transmission performance score;
Wherein, the transmission performance parameters include at least one of signal transmission power, signal reception strength and packet loss rate.

In some embodiments of the present application, the level determination unit includes:
An acquisition subunit, configured to obtain the mapping relationship set, the mapping relationship set including the mapping relationship between the preset transmission performance score and the preset transmission performance level;
A third determination subunit, configured to determine the transmission performance level corresponding to the transmission performance score based on the mapping relationship.

In some embodiments of the present application, the transmission performance level is the current transmission performance level collected in the current frequency period, and the determination module 301 includes:
A period acquisition unit, configured to acquire the historical transmission performance level and the historical audio reading cycle corresponding to the historical transmission performance level of the audio transmission link, and the historical transmission performance level is the transmission performance level collected in the previous frequency period of the current frequency period.

A first cycle determination unit configured to, if the current transmission performance level is higher than the historical transmission performance level, decrease the historical audio reading cycle according to a preset cycle adjustment threshold to obtain the audio reading cycle corresponding to the current transmission performance level;

A second cycle determination unit, configured to, if the current transmission performance level is lower than the historical transmission performance level, increase the historical audio reading cycle according to a preset cycle adjustment threshold to obtain the audio reading cycle corresponding to the current transmission performance level;

A third cycle determination unit configured to, if the current transmission performance level is equal to the historical transmission performance level, use the historical audio reading cycle as the audio reading cycle corresponding to the current transmission performance level, and.

In embodiments of the present application, the determination module 301, is configured to determine an audio reading cycle based on the transmission performance level of the audio transmission link if an audio transmission link is established with a peer device. Then, the reading module 302 reads target audio data from the audio buffer of the current device according to the audio reading cycle. Subsequently, the transmission module 303 transmits the target audio data to the peer device via the audio transmission link.

In embodiments of the present application, the audio reading cycle is determined based on the transmission performance level of the audio transmission link, the target audio data is read according to the audio reading cycle and transmitted, and the audio reading frequency is adjusted according to the transmission performance, ensuring that reading and transmission of audio are able to fully utilize the transmission performance of the audio transmission link to improve the audio transmission quality while meeting transmission performance requirements.

Furthermore, the present application also provides an electronic device. As shown in FIG. 8, which shows a schematic structural diagram of the electronic device involved in the present application, specifically:
The electronic device may include a processor 401 with one or more processing cores, a memory 402 having one or more computer-readable storage media, a power supply 403, an input unit 404, etc. Those skilled in the art will understand that the structure of the electronic device shown in FIG. 8 does not constitute a limitation of the electronic device and may include more or fewer components than illustrated, or combine some components, or have a different arrangement of components. Wherein:
The processor 401 is the control center of the electronic device, connecting various parts of the entire electronic device using various interfaces and lines. By running or executing software programs and/or modules stored in the memory 402 and invoking data stored in the memory 402, it performs various functions of the electronic device and processes data, thereby monitoring the electronic device overall. Optionally, the processor 401 may include one or more processing cores. Preferably, the processor 401 may integrate an application processor and a modem processor, where the application processor mainly processes the operating system, user interface, applications, etc., and the modem processor mainly processes wireless communication. It is understandable that the aforementioned modem processor may also not be integrated into the processor 401.
The memory 402 may be used to store software programs and modules. The processor 401 executes various functional applications and data processing by running the software programs and modules stored in the memory 402. The memory 402 may mainly include a storage program area and a storage data area. The storage program area may store an operating system, application(s) required for at least one function (e.g., sound playback function, image playback function, etc.), etc. The storage data area may store data created according to the use of the electronic device, etc. Furthermore, the memory 402 may include high-speed random access memory and may also include non-volatile memory, such as at least one magnetic disk storage device, flash memory device, or other volatile solid-state storage device. Accordingly, the memory 402 may also include a memory controller to provide the processor 401 with access to the memory 402.
The electronic device also includes a power supply 403 that supplies power to various components. Preferably, the power supply 403 may be logically connected to the processor 401 through a power management system, thereby managing functions such as charging, discharging, and power consumption through the power management system. The power supply 403 may also include any component such as one or more DC or AC power sources, a recharging system, a power failure detection circuit, a power converter or inverter, a power status indicator, etc.
The electronic device may also include an input unit 404. The input unit 404 may be used to receive input numeric or character information and generate key, mouse, joystick, optical, or track signal inputs related to user settings and function control.

Although not shown, the electronic device may also include a display unit, etc., which will not be repeated here. Specifically, in this embodiment, the processor 401 of the electronic device will load the executable file corresponding to the process of one or more applications into the memory 402 according to the following instructions and run the application stored in the memory 402 by the processor 401, thereby implementing the steps in any audio processing method provided by the embodiments of the present application.

The specific implementation of the above operations can be found in the previous embodiments and will not be repeated here.

In this embodiment of the present application, when an audio transmission link is established between the current device and a peer device, an audio reading cycle is determined based on the transmission performance level of the audio transmission link. Target audio data is read from the audio buffer of the current device according to the audio reading cycle, and the target audio data is transmitted to the peer device via the audio transmission link. By determining the audio reading cycle based on the transmission performance level of the audio transmission link, and when using this audio reading cycle to read target audio data and transmit this target audio data, the audio reading frequency is adjusted according to the transmission performance. This ensures that audio reading and transmission can meet transmission performance requirements while also fully utilizing the transmission performance of the audio transmission link, thereby improving audio transmission quality.

Those of ordinary skill in the art will understand that all or part of the steps of the various methods in the above embodiments can be completed by instructions or by instructions controlling related hardware. These instructions can be stored in a computer-readable storage medium and loaded and executed by a processor.

To this end, the present application provides a computer-readable storage medium. The computer-readable storage medium stores a computer program. The computer program can be loaded by a processor to execute the steps in any audio processing method provided by the present application.

The specific implementation of the above operations can be found in the previous embodiments and will not be repeated here.

The computer-readable storage medium may include: read-only memory (ROM), random access memory (RAM), magnetic disks, optical disks, etc.

Because the instructions stored in the computer-readable storage medium can execute the steps in any audio processing method provided by the present application, the beneficial effects achievable by any audio processing method provided by the present application can be realized. For details, refer to the previous embodiments, which will not be repeated here.

The above provides a detailed introduction to an audio processing method, device, electronic device, and computer-readable storage medium provided by the present application. Specific examples are used herein to explain the principles and implementation of the present invention. The description of the above embodiments is only for helping to understand the method of the present invention and its core ideas. At the same time, for those skilled in the art, based on the ideas of the present invention, there will be changes in the specific implementation and application scope. In summary, the content of this specification should not be construed as limiting the present invention.

It should be noted that in the specific implementation of the present application, data related to audio data generated by the television, application types, transmission performance parameters of the Bluetooth link, television models, address information, Bluetooth headset models, address information, etc., are involved. When the above embodiments of the present application are applied to specific products or technologies, user permission or consent is required, and the collection, use, and processing of related data must comply with relevant laws, regulations, and standards of the relevant countries and regions.

1. An audio processing method applied to a current device, comprising:
when an audio transmission link is established with a peer device, determining an audio reading cycle based on a transmission performance level of the audio transmission link;
reading target audio data from an audio buffer of the current device according to the audio reading cycle; and
transmitting the target audio data to the peer device via the audio transmission link.

2. The method according to claim 1, wherein after the audio transmission link is established with the peer device, the method further comprises:
determining a current usage scenario of the audio transmission link based on time information of currently started threads; and
adjusting a storage capacity of the audio buffer according to the current usage scenario.

3. The method according to claim 2, wherein the determining the current usage scenario of the audio transmission link based on the time information of the currently started threads comprises:
determining a currently running application based on the time information of the currently started threads; and
determining the current usage scenario of the audio transmission link based on an application type of the currently running application.

4. The method according to claim 2, wherein the transmitting the target audio data to the peer device via the audio transmission link comprises:
storing the target audio data in an audio queue to be transmitted of the current device; and
transmitting the target audio data in the audio queue to be transmitted to the peer device via the audio transmission link.

5. The method according to claim 4, wherein the adjusting the storage capacity of the audio buffer according to the current usage scenario comprises:
adjusting a storage capacity of the audio buffer and a storage capacity of the audio queue to be transmitted based on a preset capacity adjustment threshold and the current usage scenario.

6. The method according to claim 1, wherein before the determining the audio reading cycle based on the transmission performance level of the audio transmission link, the method further comprises:
acquiring transmission performance parameters of the audio transmission link according to a preset frequency or period;
determining a transmission performance score based on reference weights corresponding to the transmission performance parameters; and
determining the transmission performance level of the audio transmission link based on the transmission performance score;
wherein the transmission performance parameters comprise at least one selected from:
signal transmission power, signal reception strength, and packet loss rate.

7. The method according to claim 6, wherein the determining the transmission performance level of the audio transmission link based on the transmission performance score comprises:
acquiring a mapping relationship set, wherein the mapping relationship set comprises a mapping relationship between preset transmission performance scores and preset transmission performance levels; and
determining the transmission performance level corresponding to the transmission performance score according to the mapping relationship.

8. The method according to claim 6, wherein the transmission performance level is a current transmission performance level acquired in a current frequency or period, and the determining the audio reading cycle based on the transmission performance level of the audio transmission link comprises:
acquiring a historical transmission performance level of the audio transmission link and a historical audio reading cycle corresponding to the historical transmission performance level, wherein the historical transmission performance level is acquired in a previous frequency or period of the current frequency or period;
when the current transmission performance level is higher than the historical transmission performance level, decreasing the historical audio reading cycle according to a preset cycle adjustment threshold to obtain the audio reading cycle corresponding to the current transmission performance level;
when the current transmission performance level is lower than the historical transmission performance level, increasing the historical audio reading cycle according to the preset cycle adjustment threshold to obtain the audio reading cycle corresponding to the current transmission performance level;
when the current transmission performance level is equal to the historical transmission performance level, using the historical audio reading cycle as the audio reading cycle corresponding to the current transmission performance level.

9. The method according to claim 2, wherein the adjusting the storage capacity of the audio buffer according to the current usage scenario comprises:
when the current usage scenario is a high sound quality scenario, increasing the storage capacity of the audio buffer;
when the current usage scenario is a low latency scenario, decreasing the storage capacity of the audio buffer.

10. The method according to claim 6, wherein the transmission performance parameters comprise signal transmission power, signal reception strength, and packet loss rate, wherein a reference weight of the signal transmission power is 20%, a reference weight of the signal reception strength is 20%, and a reference weight of the packet loss rate is 60%.

11-18. (canceled)

19. An electronic device comprising a memory and a processor, wherein the memory is configured to store computer programs that, when executed by the processor, cause the processor to implements:
when an audio transmission link is established with a peer device, determining an audio reading cycle based on a transmission performance level of the audio transmission link;
reading target audio data from an audio buffer of a current device according to the audio reading cycle; and
transmitting the target audio data to the peer device via the audio transmission link.

20. A non-transitory computer-readable storage medium, wherein the computer-readable storage medium stores a computer program that, when executed by a processor, implements:
when an audio transmission link is established with a peer device, determining an audio reading cycle based on a transmission performance level of the audio transmission link;
reading target audio data from an audio buffer of a current device according to the audio reading cycle; and
transmitting the target audio data to the peer device via the audio transmission link.

21. The electronic device according to claim 19, wherein the processor is further configured to, after the audio transmission link is established with the peer device:
determine a current usage scenario of the audio transmission link based on time information of currently started threads; and
adjust a storage capacity of the audio buffer according to the current usage scenario.

22. The electronic device according to claim 21, wherein to determine the current usage scenario of the audio transmission link based on the time information of the currently started threads, the processor is further configured to:
determine a currently running application based on the time information of the currently started threads; and
determine the current usage scenario of the audio transmission link based on an application type of the currently running application.

23. The electronic device according to claim 21, wherein to transmit the target audio data to the peer device via the audio transmission link, the processor is further configured to:
store the target audio data in an audio queue to be transmitted of the current device; and
transmit the target audio data in the audio queue to be transmitted to the peer device via the audio transmission link.

24. The electronic device according to claim 23, wherein to adjust the storage capacity of the audio buffer according to the current usage scenario, the processor is further configured to:
adjust a storage capacity of the audio buffer and a storage capacity of the audio queue to be transmitted based on a preset capacity adjustment threshold and the current usage scenario.

25. The electronic device according to claim 19, wherein the processor is further configured to:
acquire transmission performance parameters of the audio transmission link according to a preset frequency or period;
determine a transmission performance score based on reference weights corresponding to the transmission performance parameters; and
determine the transmission performance level of the audio transmission link based on the transmission performance score;
wherein the transmission performance parameters comprise at least one selected from:
signal transmission power, signal reception strength, and packet loss rate.

26. The electronic device according to claim 25, wherein to determine the transmission performance level of the audio transmission link based on the transmission performance score, the processor is further configured to:
acquire a mapping relationship set, wherein the mapping relationship set comprises a mapping relationship between preset transmission performance scores and preset transmission performance levels; and
determine the transmission performance level corresponding to the transmission performance score according to the mapping relationship.

27. The electronic device according to claim 25, wherein the transmission performance level is a current transmission performance level acquired in a current frequency or period, and the processor is further configured to:
acquire a historical transmission performance level of the audio transmission link and a historical audio reading cycle corresponding to the historical transmission performance level, wherein the historical transmission performance level is acquired in a previous frequency or period of the current frequency or period;
when the current transmission performance level is higher than the historical transmission performance level, decreasing the historical audio reading cycle according to a preset cycle adjustment threshold to obtain the audio reading cycle corresponding to the current transmission performance level;
when the current transmission performance level is lower than the historical transmission performance level, increasing the historical audio reading cycle according to the preset cycle adjustment threshold to obtain the audio reading cycle corresponding to the current transmission performance level;
when the current transmission performance level is equal to the historical transmission performance level, using the historical audio reading cycle as the audio reading cycle corresponding to the current transmission performance level.

28. The electronic device according to claim 21, the processor is further configured to:
when the current usage scenario is a high sound quality scenario, increasing the storage capacity of the audio buffer;
when the current usage scenario is a low latency scenario, decreasing the storage capacity of the audio buffer.
